(19) United States
(12) Patent Application Publication
(10) Pub. No.: US 2008/0177750 A1
(43) Pub. Date: Jul. 24, 2008

(54) Internet-Based Bearing Tracking Application

(75) Inventor: Stephen Ricker, Ann Arbor, MI (US)

Correspondence Address: CROWELL & MORING LLP;INTELLECTUAL PROPERTY GROUP, P.O. BOX 14300, WASHINGTON, DC, 20044-4300, US

(73) Assignee: NSK Corporation, Ann Arbor, MI (US)

(21) Appl. No.: 11/968,882

(22) Filed: Jan. 3, 2008

Related U.S. Application Data
(60) Provisional application No. 60/878,410, filed on Jan. 4, 2007.

(51) Int. Cl. G06F 17/30

(52) U.S. Cl. 707/10; 707/E17.032

(57) ABSTRACT

A bearing tracking system and method are provided, in which a bearing tracking application program is executed on a computer system to process information requests from a variety of system users received over communications links such as the Internet, and to present the users with an interface, such as an Internet browser page, containing output from processing bearing-related information stored in a database preferably hosted and maintained by the bearing supplier. The users may include different categories of entities, each with their own rights and responsibilities, such as customers or end users, third-party maintenance and refurbishing service providers, and organizations of the bearing supplier, such as engineering and marketing organizations.

This application claims priority to U.S. provisional patent application Ser. No. 60/878,410 filed Jan. 4, 2007, the disclosure of which is expressly incorporated herein by reference.

### BACKGROUND AND SUMMARY OF THE INVENTION

The present invention relates to a method and apparatus for control and management of bearing applications, and in particular management of interaction between bearing manufacture, bearing field applications, and bearing maintenance and refurbishment activities associated with high value bearings.

The present invention is directed to an innovative product for the bearing market, which is referred to as a web-based bearing tracking application (BTA). The proposed application provides, inter alia, a database and web-based user interface for tracking bearings installed in the field.

As a rule within general industry, bearing end users tend to be firmly fixed in buying bearings from bearing companies that they have been doing business with for years, and will only shift bearing brands if there is an advantage to do so. Users typically indicate that they will only shift bearing suppliers if there are significant advantages in non-technical areas (such as lower pricings, superior delivery timing, and perceived product superiority) and/or in technical areas (such as a better product or additional or superior supplier services).

The brand shifting mechanism that results in the greatest market increases and sales revenue is when a product and/or a service is classified as innovative, with no similarity in the market place. For a bearing company to be successful at increasing market share and sales, their potential customers need to recognize the benefits and differentiations that is a result of an innovation. Additionally, if a product or service is innovative, any company that subsequently attempts to copy the innovation is typically perceived as an industry follower that lacks imagination and understanding of the end users' needs.

In the case of the industrial bearing market, and in particular the industrial bearing maintenance market, better asset management is an emerging need. Asset management in this context refers to increasing a machine and machine component reliability. This is understandable because the business environment in the industrial bearing maintenance market tends to push for process efficiency increases that result in productivity gains and thus higher profit.

End users do not have a need to track every bearing in their facility. For example, bearings in small motors and movable equipment do not need tracking. However, for bearings which are critical to the end user, such as large and expensive bearings used in applications that require high reliability and long life, improved bearing tracking can provide substantial reliability and profit improvement opportunities. For example, spherical roller bearings for paper machines and other such critical paper applications, as well as roll neck bearings and others steel mill applications are examples of bearings that end users want to track through their entire life.

To achieve good asset management, a bearing end user and/or customer has a need to manage all aspects of the entire life of the machine and machine component. The reason for this is because if a machine or machine component stops to function, production stops and efficiency decreases. It is clear that if the end user is able to avoid an unexpected stoppage and forecast the machine and machine component's life, reliability is increased and efficiency increases which results in higher profits.

In order to provide end users with some form of at least partial asset management during a bearing's life, various items of equipment, hardware, and software have been provided, including for example: predictive analysis and predictive maintenance tools, and bearing condition monitoring software. Most current machine asset management tools have the significant disadvantage of being accounting-based, not maintenance-based, i.e., they can report when a bearing was bought and perhaps when it was installed, but they often cannot shed any light on other important bearing management information, such as bearing performance, status, or important operational events during bearing installation, removed, operation, machinery shutdown, rebuilds, etc. Thus, these various piece-meal elements have not provided a satisfactory, all-encompassing asset management solution which integrates all the desired functions and services in a manner which provides the end user with a simple, convenient access to support and services from a bearing supplier and third parties such as bearing refurbishment service providers. In accordance with the present invention, preferably all the end user should be required to do is supply and get information through a computer and an internet web browser. The end user would then have access to a variety of bearing support information.

The proposed bearing tracking application includes a database and web-based user interface for tracking bearings installed in the field, preferably hosted by the bearing supplier. An embodiment of the system has four primary user categories, each with their own rights and responsibilities, and which will gain specific value from its use: end user, third-party maintenance/refurbishing company, bearing supplier engineering organization, and bearing supplier sales organization.

The bearing tracking application may, for example, focus exclusively on a particular type of bearing, such as large spherical roller bearings. Alternatively, different types of bearings may be simultaneously supported, such as taper roller bearings and cylindrical roller bearings, where desired. As a further alternative, the user could be provided with an expandable system, in which certain bearings are first addressed (for example, spherical roller bearings, which typically are refurbished twice as often as tapered roller bearings), with less frequently used bearings being added later (such as later addition of cylindrical roller bearings, which are typically used less often that spherical or tapered roller bearings. Other related components and activities may also be included, such as spindle rebuilds, gears, pulley and drive systems, roller assemblies, pneumatic or hydraulic valves and cylinders.

The information for the database portion may be entered into the system manually, or may be imported from existing data sources, for example from a bearing supplier's bearing installation databases. Examples of data that may be stored and accessed via the system include:
Customer information (end user name, end user location, bearing supplier sales representative, bearing supplier engineer/field technician, distributor name, distributor location, distributor salesman name, etc.)
Machine information (type of machine in which bearing is installed, product being made, roll/shaft operating conditions (speed, temp., radial load, axial load, shock loading, etc), lubrication information (ambient temperature, flow rate, lubricant specifications, etc.))
Bearing information (bearing part number, maker, date of purchase, where purchased, date installed in/on machine, roll name or equipment the bearing was installed into, worker who installed the bearing, condition of bearing before and after installation, side of roll/shaft bearing was installed on, etc.)
Installation information (bearing bench clearance, reduction in clearance, axial displacement, roll and journal condition & diameter, journal taper measurement (if applicable), adapter sleeve or removal sleeve information (if applicable), housing diameter & type, installation notes, etc.)
Bearing operation information (roll rpm changes, loading changes, lubrication changes, sudden unusual condition changes, shut down times and durations, significant vibration reading changes, etc.)
First and second bearing refurbish information (date roll/shaft taken out of machine, vendor doing refurbish work, date refurbish done, date bearing put back on roll/shaft, roll/shaft bearing put on, worker who reinstalled the bearing on the roll, did bearing fail, will a technical failure report be needed, who will do the technical report, etc.)

The activities and access of the various users of the present bearing tracking application are further discussed below.

End users are entities which possess and operate machinery contain bearings, including bearings provided by the supplier who is hosting the bearing tracking application, and/or the bearings of other bearing suppliers. The database capabilities of the system to address a wide variety of bearing installation sites, whether a single site having only a few bearings, or sites having multiple machines with hundreds or even thousands of installed bearings.

End users will use the system to enter and track data about what bearings they have in each application and position, and what work has been performed on them over time.

When first signing on to the system, the end users will receive a username/password, for example from their bearing supplier's sales representative. The end user may then change their password, and create new users and passwords under their own account.

The user may then create records for each bearing they wish to track. If the bearing is a part supplied by the bearing supplier, the end user preferably will be able to pick the bearing from a pre-established database of bearing designs, preferably assisted by a “wizard”-based user interface. This database will further provide the end user with information such as engineering specifications, installation details, and so on. Alternatively, if such information is not available, the user will have the opportunity to enter as much of that information as they wish manually. The user may also add installation and use details (e.g., installation date, identification of maintenance personnel, etc.). Further, the system will be able to accept an end-user bearing identifier, such as a serial number. If no bearing identifier is supplied, the system will also have the ability to generate a unique identification, which the user will be able to associate with the bearing (such as by inscribing an assigned serial number onto the part).

During the lifetime of the bearing, the end user will be able to employ the web-based interface of the bearing tracking application to enter information regarding any activity pertaining to the bearing, such as bearing maintenance, movement to a different machine or application location, bearing vibration analysis date, etc.

End users will also be able to obtain bearing reports from their interface, such as a “history” for a given bearing, without the need to maintain extensive, expensive on-site bearing data accumulation and storage facilities.

The bearing tracking application may also include maintenance and predictive features which allow the end user to receive Internet-based reports and recommendations for maintenance and refurbishment of various bearings (whether installed or at off-site service locations). Reports, such as “Refurb Status” reports for each bearing may be provided to the end user to permit them to easily track the needs and status of their bearings, again without the need for extensive on-site data acquisition and storage systems. Thus, an end-user would be provided with a readily-accessible system which allows them to see when a specific bearing was received for processing by the bearing supplier or a third-party bearing refurbishing company, whether it the scheduled work on the bearing has been finished, and/or the bearing's return shipment status.

Bearing supplier sales representatives will be provided the ability to create new customer accounts, describe the end user, enter the customer address and contact information, describe what the customer manufactures, and assign an initial client username and login.

Bearing supplier sales representatives will also be able to review data provided by end users, and prepare various reports and customer recommendations based on the end user data, such as when a new bearing will be needed or when a existing bearing will likely need refurbishing. The bearing supplier-maintained bearing tracking application will further provide the supplier's representatives with the ability to cross-index and analyze information, for example, obtain information pertaining to a specific bearing family across some or all of the bearing end users.

Third-party bearing servicing/refurbishment service providers who receive a bearing from an end user for refurbishment will be able to easily access information from the bearing tracking application's databases, without the need to receive and/or handle bearing history and specification information from the end user. Moreover, if the refurbishment of the bearing is handled by the bearing supplier's representative, the refurbishment service provider would be able to access all the bearing record information it needs, without there being any need to reveal the identity of the end user if so desired.

The refurbishment service provider may be provided with the ability to s update the bearing's record with information on the services performed, e.g., the personnel who performed the work, what work was done, technical information such as refurbished bearing dimensions, further maintenance recommendations, etc. Alternatively, this information may be entered into the bearing tracking application by the end user or by the bearing supplier as a service to the end user. This information should be available to the end user for review once the rebuilt bearing is received back from service. At that time the end user may add more information as needed, e.g., where the bearing and/or roll was reinstalled into the machine, who installed it, when it was installed, and if stored how long and where it was stored.

The bearing supplier's marketing and engineering organizations will be able to create new sales representative accounts and third party service provider accounts. The bearing supplier's marketing and engineering organizations can be expected to use information extracted from the bearing tracking application for providing end user services, such as tracking and evaluating when new bearings are needed by a specific customer and/or by the industry as a whole, what type of bearings are commonly used in a given application, when bearings are need to be refurbished, the type of work that is performed by bearing type, end user bearing usage and problems, and so on. The application database information would also be useful for analysis of bearing performance trends, identification of key markets and application needs, problem tracking (both within an end user's facilities and across multiple end users), and managing bearing production (both projected production requirements and technical performance).

The bearing tracking application is preferably written as an ASP.NET application. The application preferably would be hosted by the bearing supplier on its information technology assets (typically, a secure server arrangement) using well-known client-server relationships an application programs. The bearing tracking application would be accessible via a conventional computer terminal over a communications link, preferably an intranet used by the bearing supplier's personnel, and via the Internet by end users and third-party bearing service providers. The use of Internet-based applications and communications further facilitates easy modification and updating of any client-end programming, eliminating the need for costly and time-consuming transfer of physical media (e.g., CDs) to end users or third parties.

Among the advantages of this system to the end user are: lower cost for bearing asset management due to elimination of on-site management assets and related support; simplified bearing life prediction; simplified bearing refurbishment planning, service procurement and tracking; and improved access to sophisticated bearing management tools maintained by the bearing supplier. For end users which do not use bearing asset management tools and who obtain bearings from the bearing tracking application supplier, the bearing information and installation information provided by the bearing tracking application will be very easy to access and employ in their bearing asset management planning, e.g., providing improved ability to forecast bearing changes, avoid unexpected break downs, gain better control of their bearing inventory, and predict machines stops due the bearing problems, correct problems before they get worst. For end users which already use rudimentary bearing asset management tools, the present bearing tracking application will provide improved bearing and bearing installation information and calculation tools, saving the end user significant manpower from its existing asset management program (e.g., eliminating the need to collect information, both internally and externally, from a variety of sometimes conflicting bearing information sources in order to then develop a bearing servicing plan).

### BRIEF DESCRIPTION OF THE DRAWINGS

FIG. 1 is a schematic illustration of a bearing tracking system in accordance with an embodiment of the present invention.

FIG. 2 is a schematic illustration of a computer system supporting a bearing monitoring system in accordance with an embodiment of the present invention.

FIG. 3 is an sample Internet browser page containing bearing customer information outputted from a bearing tracking application program in accordance with an embodiment of the present invention.

FIG. 4 is an sample Internet browser page containing bearing maintenance and refurbishing service provider information outputted from a bearing tracking application program in accordance with an embodiment of the present invention.

FIG. 5 is an sample Internet browser page containing information useable by a bearing supplier marketing department outputted from a bearing tracking application program in accordance with an embodiment of the present invention.

### DETAILED DESCRIPTION

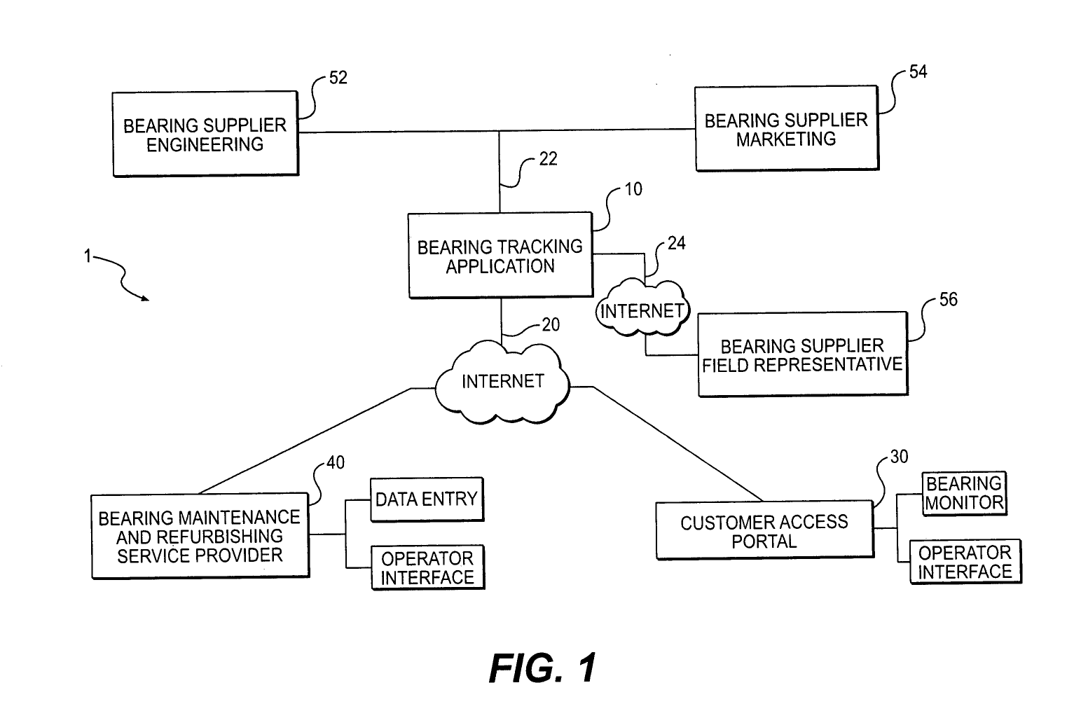

FIG. 1 shows an embodiment of bearing tracking system executing a bearing tracking application on a central server computer 10. The bearing tracking application program in this embodiment is executed on server computer 10, however, execution of portions of the application program may be performed on more than one computer.

Communications links 20, 22, 24 permit access to the bearing tracking server computer 10 by one or more customer computers 30, bearing maintenance and refurbishing service providers 40, and bearing supplier organization entities, such as bearing supplier engineering department 52, bearing supplier marketing department 54 and bearing supplier field representatives 56. The communications links may be any form of communication which supports data transfer, wired or wireless. In the embodiment shown in FIG. 1, the customer 30, bearing maintenance and refurbishing service provider 40 and bearing supplier field representative 56 communicate with the central server computer over communications links 20, 24 via the Internet using internet protocol (IP) communications, the details of which are well known and thus not discussed further. The communications link 22 by which the bearing supplier engineering department 52 and bearing supplier marketing department 54 communicate with the central server computer 10 in this embodiment is a local area network (LAN). Alternatively, where the bearing supplier's facilities housing the central server computer 10 are remote from other supplier organization entities, the communications link 22 may also be via the Internet, for example, using a secure virtual private network (VPN) remote communications protocol.

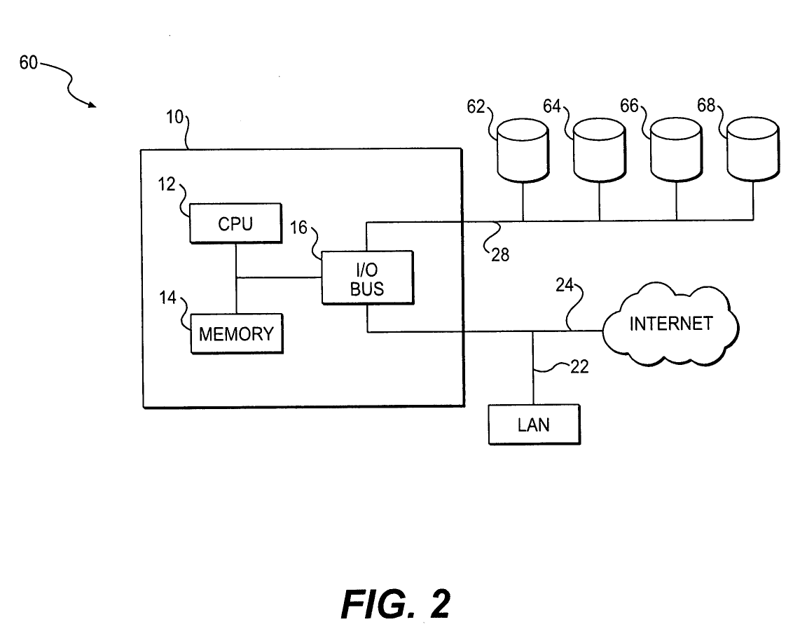

FIG. 2 provides a schematic illustration of the central server computer 10 and associated connections. The computer includes a central processing unit (CPU) 12 for executing the bearing tracking application program, computer memory 14 supporting CPU 12's program execution, and an input/output (I/O) bus 16 which handles external communications to and from the computer 10. The remaining components of the computer are well known, and therefore are not illustrated in FIG. 2.

In this embodiment, the I/O bus 16 handles communications with users on the bearing supplier's LAN 22 and users communicating over Internet link 24. The computer 10 also communicates with one or more database storage facility 60 via communications link 28 to store and retrieve the information pertaining to bearings that is processed by the bearing tracking application program. The database storage facility includes database storage units 62, 64, 66, 68 which may be arranged to store bearing-related information in a variety of organizational structures. For example, database storage unit 62 may contain customer information, including customer name, location, and the identities of the customer's bearing supplier sales representative, bearing supplier engineer and/or field technician, and distributor name and contact information. Database storage unit 64 may contain technical information related to bearings, including bearing type-specific design information and bearing application information, e.g., bearing part number, maker, date of purchase, date installed, installer identification, bearing condition before and after installation, and specific installation location (e.g., which shaft of the machine). Database storage unit 66 may contain bearing operating condition information, for example, bearing bench clearance, reduction in clearance, axial displacement, roll and journal condition & diameter, journal taper measurement, adapter sleeve or removal sleeve information, housing diameter & type, installation notes, bearing operating speed and loading, shutdown times and durations, vibration readings and unusual condition reports). Database storage unit 68 may contain bearing maintenance and refurbishment information, including the date a shaft is taken out of machine, identification of the service provider doing the maintenance and/or refurbishment work, the date of refurbish refurbishment, the date the bearing was reinstalled in the machine, bearing condition and failure mode information, and identification of technical reports on refurbished bearings.

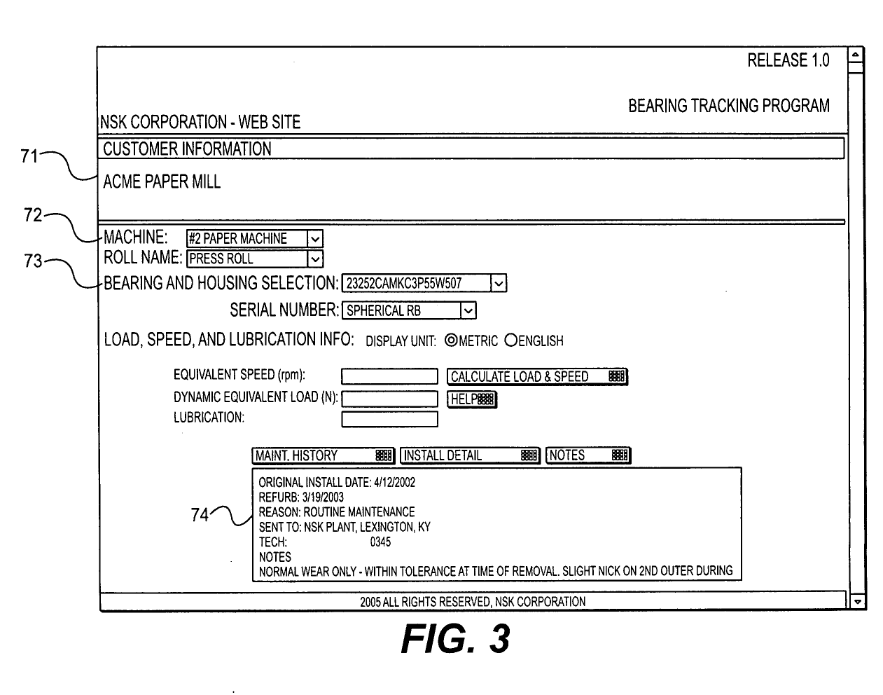

FIG. 3 is an sample Internet browser page containing bearing customer information outputted from a bearing tracking application program. A bearing customer may use a customer access portal 30 (for example, a computer with a connection to the Internet) at the customer's facility to access the central server computer 10 maintained by the bearing supplier. In response to the customer's request for information concerning a particular bearing, the bearing tracking application program being executed on the central server 10 computer accesses the appropriate storage locations in database storage facility 60, retrieves the requested information, and outputs the information to the customer in the form of data which may be rendered on the display of the customer's computer 30, for example, in the format shown in FIG. 3. As can be seen in FIG. 3, the bearing information may include information identifying the customer 71, the bearing application 72, bearing identification 73; and detailed information 74 on the maintenance and installation history of the bearing. Further, if authorized by the custodian of the central server computer 10 and database storage facility 60 (in the present embodiment, the bearing supplier), the customer may be permitted to transmit bearing-related information to the central server computer 10 for processing by the bearing tracking application program and storage in database storage facility 60. The customer may also utilize the bearing tracking application program as a communications hub to process, for example, requests for information or instructions to other users of the bearing tracking system.

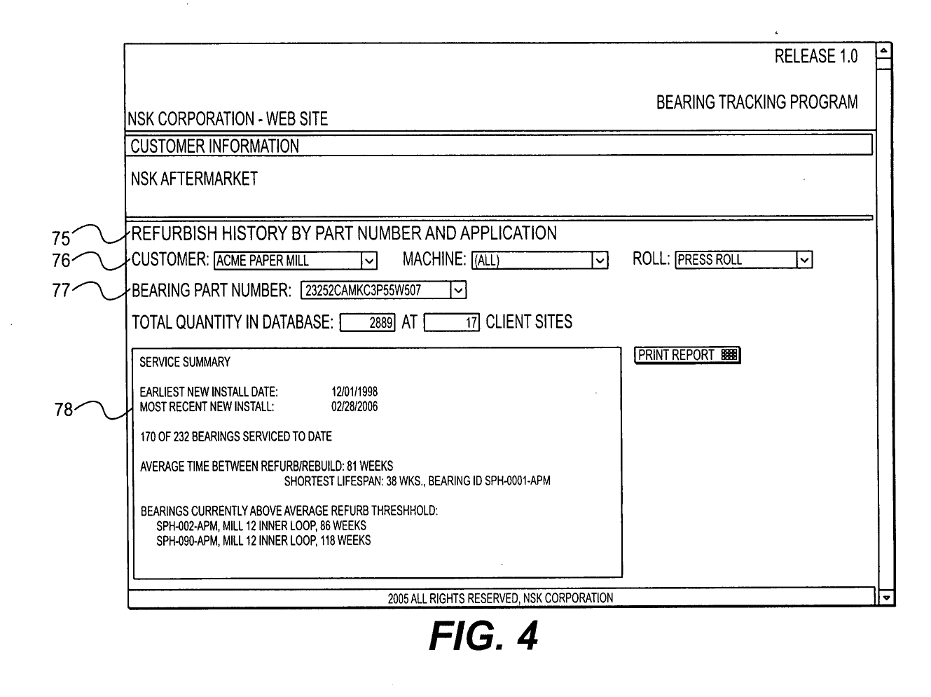

FIG. 4 is an sample Internet browser page containing bearing maintenance and refurbishing service provider information outputted from a bearing tracking application program. As with the case of a customer, the third party service provider interacts with the bearing tracking application program by accessing the central server computer 10 through the communications link 20 to request In the example shown in FIG. 4, the bearing tracking application program may output a bearing refurbishment history 75 for a particular bearing, including information such as customer identification 76, bearing identification 77 and bearing servicing data 78. As with the customer Internet browser interface, if permitted by the custodian, the third party service provider may provide information to be processed by the bearing tracking application program for storage in the appropriate database storage unit in storage facility 60.

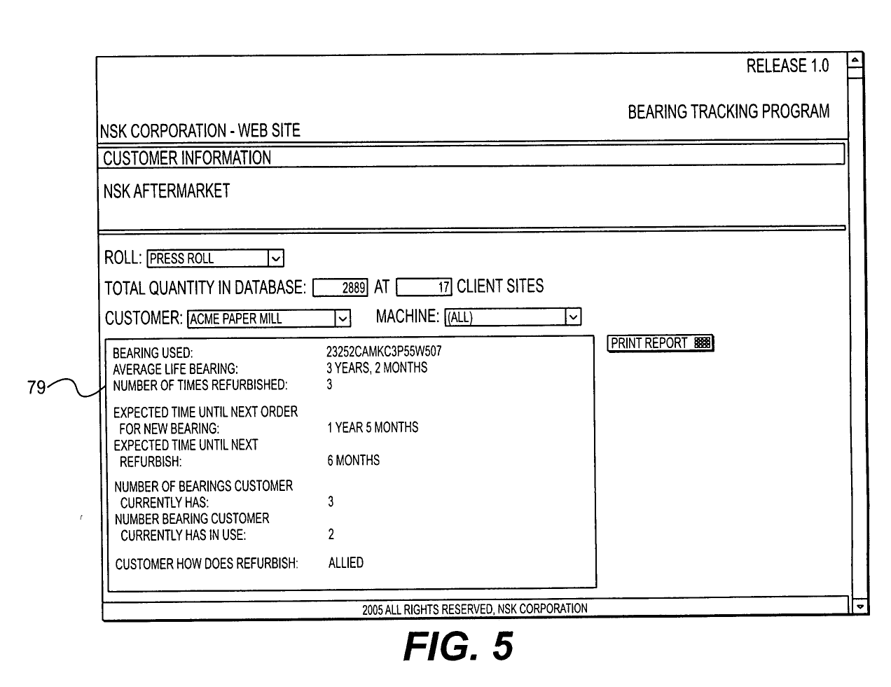

FIG. 5 is an sample Internet browser page containing information useable by a bearing supplier marketing department outputted from a bearing tracking application program. A member of the bearing supplier's marketing department may be permitted access via local area network link 22 to, for example, obtain information 79 on bearing performance, predicted lifetime, service status, etc., in order to, for example, plan bearing marketing activities, identify potential sales and service revenue opportunities, and coordinate with the bearing supplier engineering department to address customer bearing design, application and maintenance issues.

The bearing tracking application program need not be limited to outputting information on a single bearing at a time, but may instead format and present output regarding multiple bearings simultaneously and/or sequentially. The bearing data may be grouped and analyzed in different manners depending on the user needs and desires, for example, presenting information based on type of bearing (e.g., a listing of all tapered roller bearings, cylindrical roller bearings or spherical roller bearings installed in one or more customer facilities. In addition, the bearing tracking application program need not be limited to bearing data processing, but may include additional functionality, such as presenting a prospective customer with bearing design information and bearing selection tools to assist in identifying an appropriate bearing for the customer's machinery application.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A bearing tracking system, comprising:
a central computer system, said central computer system including at least one computer accessible by authorized users via at least one communications link, said computer executing a program for generating responses to user requests for bearing information;
a bearing tracking database accessible by the central computer system, said bearing tracking database including at least one of bearing identification information, installed bearing performance information, bearing maintenance history information, bearing servicing information, bearing application and bearing lifetime information,
wherein the central computer system accesses the information stored in the bearing tracking database to prepare bearing data output in response to user requests for bearing information.

2. The bearing tracking system of claim 1, wherein
the at least one communications link includes a packet-switched communications link using an Internet Protocol, and
the program for generating responses to user requests includes a user interface based on an Internet browser application program.

3. The bearing tracking system of claim 2, wherein the authorized users include one of a bearing manufacturer, a bearing customer and a bearing refurbisher.

4. The bearing tracking system of claim 3, wherein the information in the bearing tracking database is maintained by the bearing manufacturer.

5. A method of tracking bearing information, comprising the acts of:
populating a bearing tracking database with at least one of bearing identification information, installed bearing performance information, bearing maintenance history information, bearing servicing information, bearing application and bearing lifetime information;
accessing via at least one communications link information in the bearing tracking database through a central computer system executing a program for generating responses to user requests for bearing information, said program executing on the central computer system receiving an authorized user request for bearing tracking information and preparing a bearing information output; and
transmitting the bearing information output in response to the authorized user request.

6. The method of claim 5, wherein
the at least one communications link includes a packet-switched communications link using an Internet Protocol, and
the program for generating responses to user requests includes a user interface based on an Internet browser application program.

7. The method of claim 6, wherein the act of accessing information in the bearing tracking database is conducted by at least one of a bearing manufacturer, a bearing customer and a bearing refurbisher.

8. The method of claim 7, wherein the information in the bearing tracking database is maintained by the bearing manufacturer.
